(19) United States
(12) Patent Application Publication
(10) Pub. No.: US 2023/0316757 A1
(43) Pub. Date: Oct. 5, 2023

(54) INFORMATION PROCESSING SYSTEM, INFORMATION PROCESSING APPARATUS, AND INFORMATION PROCESSING METHOD

(71) Applicant: KYOCERA Corporation, Kyoto (JP)

(72) Inventor: Shun SUGAHARA, Yokohama-shi, Kanagawa (JP)

(73) Assignee: KYOCERA Corporation, Kyoto (JP)

(21) Appl. No.: 18/042,983

(22) PCT Filed: Aug. 23, 2021
(86) PCT No.: PCT/JP2021/030874

§ 371 Date: Feb. 24, 2023

(30) Foreign Application Priority Data
Aug. 28, 2020 (JP) 2020-144647

(51) Int. Cl. G06V 20/50; G06V 10/22; H04N 23/61

(52) U.S. Cl. CPC G06V 20/50; G06V 10/22; H04N 23/61

(57) ABSTRACT

An information processing system includes an imaging unit, a gate, and a controller. The imaging unit captures an image of an imaging target in a multi-view manner to generate a captured image. The gate includes the imaging unit and allows the imaging target to pass therethrough. The controller extracts a predetermined region including the imaging target from the captured image and identifies the imaging target based on the predetermined region.

### CROSS-REFERENCE TO RELATED APPLICATIONS

The present application claims priority to Japanese Patent Application No. 2020-144647, filed on Aug. 28, 2020, which is hereby incorporated by reference herein in its entirety.

### TECHNICAL FIELD

The present disclosure relates to an information processing system, an information processing apparatus, and an information processing method.

### BACKGROUND OF INVENTION

For payment for products to be purchased in a retail store, for example, PTL 1 discloses an invention involving tracking a product from a shopping basket to a bag to determine whether the product has been appropriately scanned.

### CITATION LIST

### Patent Literature

Patent Literature 1: Japanese Unexamined Patent Application Publication No. 2011-54038

### SUMMARY

In an aspect of the present disclosure, an information processing system includes an imaging unit configured to capture an image of an imaging target in a multi-view manner to generate a captured image, a gate including the imaging unit and allowing the imaging target to pass therethrough, and a controller configured to extract a predetermined region including the imaging target from the captured image and identify the imaging target based on the predetermined region.

In another aspect of the present disclosure, an information processing apparatus includes an imaging unit configured to capture an image of an imaging target in a multi-view manner, a gate including the imaging unit and allowing the imaging target to pass therethrough, and a controller configured to extract a predetermined region including the imaging target from the image captured by the imaging unit and identify the imaging target based on the predetermined region.

In still another aspect of the present disclosure, an information processing method includes capturing, at an imaging unit included in a gate, an image of an imaging target passing through the gate in a multi-view manner, extracting a predetermined region including the imaging target from the image captured at the imaging unit, and identifying the imaging target based on the predetermined region.

### BRIEF DESCRIPTION OF THE DRAWINGS

FIG. 1 is a functional block diagram of an exemplary configuration of an information processing system in an embodiment of the present disclosure.

FIG. 2 is an external view of an information processing apparatus in an embodiment of the present disclosure.

FIG. 3 is a conceptual diagram illustrating images captured by an imaging unit in the information processing system and the information processing apparatus in the embodiments of the present disclosure.

FIG. 4 is a flowchart of an information processing method in an embodiment of the present disclosure.

FIG. 5 is a flowchart of an information processing method in another embodiment of the present disclosure, the embodiment being different from that in FIG. 4.

FIG. 6 is an external view of an information processing apparatus in another embodiment of the present disclosure.

FIG. 7 is an external view of the information processing apparatus in the present disclosure used for classification or discrimination of an imaging target on a transport path.

### DESCRIPTION OF EMBODIMENTS

In the related art, it is necessary for a user (customer) to manually sequentially scan, for example, barcodes of imaging targets (products) in order to identify products or classify the imaging targets. The related art leaves room for improvement. The present disclosure aims to achieve classification or identification of imaging targets without causing a user to manually sequentially scanning the imaging targets.

An embodiment of an information processing system to which the present disclosure is applied will be described below with reference to the drawings.

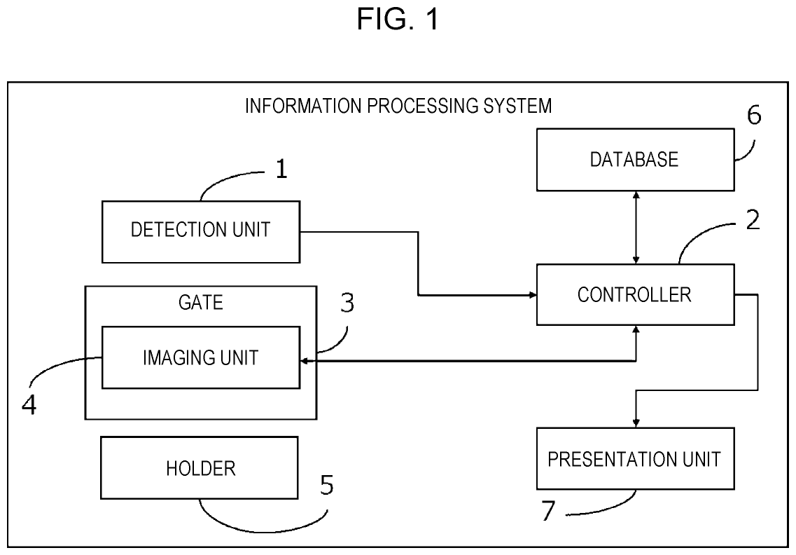

FIG. 1 a functional block diagram of an information processing system in an embodiment of the present disclosure.

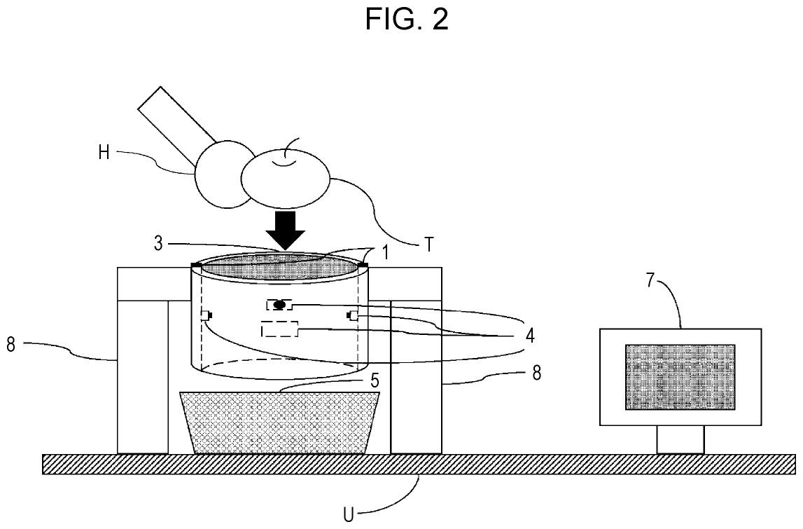

FIG. 2 is an external view of the information processing system and an information processing apparatus in an embodiment of the present disclosure. The external view illustrates a physical configuration (hardware configuration) of the information processing system and the information processing apparatus in the present disclosure.

In the present disclosure, as illustrated in FIG. 1, the information processing system includes a detection unit 1, a controller 2, a gate 3, an imaging unit 4, a holder 5, a database 6, and a presentation unit 7. The holder 5 and the presentation unit 7 may be eliminated from the components of the information processing system. In the present disclosure, as illustrated in FIG. 2, the information processing system and the information processing apparatus each include, as physical components, the detection unit 1, the gate 3, the imaging unit 4, the holder 5, and the presentation unit 7. As will be described later in Paragraph [0022], if the holder 5 is a detachable basket or bag, the information processing system may not include the holder 5 as an essential physical component. As will be described later in Paragraph [0036], the controller 2 and the database 6 may not be included in the same apparatus. The controller 2 and the database 6 may be installed in a remote area and be connected to the information processing apparatus by wired or wireless communication.

In FIG. 1, each solid-line arrow connecting the functional blocks indicates the flow of a control signal (e.g., a detection signal, an image capture signal, or a presentation signal) or information to be communicated. Communication indicated by an arrow may be wired communication, wireless communication, or a combination thereof. For wireless communication, the information processing system includes a communication unit for wireless communication conforming to various communication standards including Bluetooth (registered trademark) and IEEE 802.11. Wireless communication may be optical communication.

The detection unit 1 determines whether an imaging target T is put into the gate 3. When determining that the imaging target T is moving toward the imaging unit 4, the detection unit 1 transmits a detection signal indicating the determination to the controller 2.

The detection unit 1 may be, for example, a photoelectric sensor, a fiber sensor, a laser sensor, an ultrasonic sensor, or an image sensor. If the detection unit 1 is a photoelectric sensor, a fiber sensor, or a laser sensor, the detection unit 1 may include a light emitter and a light receiver or may include a light emitter-receiver. If the detection unit 1 is an ultrasonic sensor, the detection unit 1 may include an ultrasonic element. If the detection unit 1 is an image sensor, the detection unit 1 may include an imaging optical system and an imaging element. The imaging optical system may include optical elements, such as one or more lenses and a diaphragm. The imaging element may include a charge coupled device (CCD) image sensor or a complementary metal-oxide semiconductor (CMOS) image sensor. The image sensor may successively capture still images (a video) at any frame rate. The detection unit 1 may include one or more sensors or may include a combination of one or more types of sensors. For example, in the embodiment of FIG. 2, a light emitter and a light receiver are arranged on an upper surface (over which a user puts the imaging target T) of the gate 3.

The controller 2 transmits an image capture signal to the imaging unit 4 in response to receiving the detection signal from the detection unit 1. In response to receiving a captured image from the imaging unit 4, the controller 2 extracts a predetermined region from the captured image, and identifies the imaging target T through image recognition processing while referring to the database 6. As used herein, the term “predetermined region” refers to an imaging region in which, for example, an identifier Tm of the imaging target T or the imaging target T is seen. Examples of the identifier Tm of the imaging target T include a barcode and a QR code (registered trademark). Identifying the imaging target T through image recognition processing may involve recognizing the identifier Tm of the imaging target T seen in the captured image or specific object recognition based on pattern matching or machine learning. When receiving multiple captured images from the imaging unit 4, the controller 2 may select at least one captured image that satisfies a predetermined condition and perform image recognition processing on the selected captured image. A determination as to whether the predetermined condition is satisfied may be, for example, a determination as to whether the identifier Tm is clearly seen (i.e., whether the controller 2 can recognize the identifier Tm) or a determination as to whether the degree of reliability (confidence factor), which can be calculated in specific object recognition, of a recognition result meets a predetermined threshold. If parts of the identifier Tm are separately imaged and included in different captured images, the controller 2 may extract regions including the parts of the identifier Tm from the different captured images. The controller 2 may identify the imaging target T by performing image synthesis on the different captured images including the parts of the identifier Tm or using an image processing technique, such as structure from motion (SfM).

The controller 2 may record the identified imaging target T as registration target data.

The controller 2 may calculate a payment amount based on at least one imaging target T identified and recorded or may determine whether the imaging target T can be identified, and transmit a presentation signal to the presentation unit 7. As used herein, the term “determination as to whether the imaging target T can be identified” refers to a determination as to whether the imaging target T is successfully identified or fails to be identified. The presentation unit 7 may present the payment amount to the user to request the user to make payment or may present a result of determination as to whether the imaging target T can be identified to the user, or inform the user of the determination result.

The controller 2 may include a recording unit to store a program that executes, for example, the above-described processing, and the registration target data.

The controller 2 includes one or more processors and a memory. The processors may include a general-purpose processor that reads a specific program and performs a specific function and a dedicated processor specialized for a specific process. The general-purpose processor may include a central processing unit (CPU) or a graphics processing unit (GPU). The dedicated processor may include an application specific integrated circuit (ASIC). The processors may include a programmable logic device (PLD). The PLD may include a field-programmable gate array (FPGA). The controller 2 may be either one of a system-on-a-chip (SoC) with one processor or a plurality of processors that work together and a system in a package (SiP). The memory may include one or more of any of semiconductor memories, magnetic memories, and optical memories. The semiconductor memories may include a volatile memory and a nonvolatile memory. The magnetic memories may include a hard disk and a magnetic tape. The optical memories may include a compact disc (CD), a digital versatile disc (DVD), and a Blu-ray (registered trademark) disc (BD).

The gate 3 is installed to put the imaging target T therein. Specifically, the user puts a product (imaging target T) into the gate 3. The gate 3 includes the imaging unit 4.

The gate 3 is cylindrical, for example. The gate 3 may have a shape having a cavity therein. In this case, the information processing system may include the detection unit 1 located at an entrance of the cavity of the gate 3 and the imaging unit 4 located in the cavity. The gate 3 may include a support 8 for supporting the gate. The support 8 may be, for example, a cantilever, a bridge structure supported at each end, or a suspending structure, or may have any other shape. For example, in the embodiment of FIG. 2, the support 8 in the form of a bridge structure supports the gate 3 and is placed on an installation plane U.

In response to receiving an image capture signal from the controller 2, the imaging unit 4 captures an image of the imaging target T in a multi-view manner to generate a captured image. In other words, the imaging unit 4 captures an image of the imaging target T put into the gate 3 in a multi-view manner. A multi-view image captured by the imaging unit 4 is, for example, an entire circumferential image of the imaging target T facing an internal surface of the gate 3. The captured image, captured and generated by the imaging unit 4, is transmitted to the controller 2. The imaging unit 4 may be one of a plurality of imaging units that capture images of the imaging target T put into the gate 3 in a multi-view manner. The imaging unit 4 may include a fisheye camera or an omnidirectional camera. The imaging unit 4 may generate not only one but multiple captured images.

The imaging unit 4 may include optical elements, such as one or more lenses and a diaphragm. An imaging element may include a CCD image sensor or a CMOS image sensor. The imaging unit 4 may successively capture still images at any frame rate. Successively capturing still images can be stated as capturing a video. For example, in the embodiment of FIG. 2, four imaging units 4 are arranged on the inner surface of the cavity of the gate 3 so that images of the imaging target T can be captured in a multi-view manner.

If the detection unit 1 includes an imaging optical system and an imaging element, the imaging unit 4 may be integrated with the detection unit 1. In other words, the detection unit 1 and the imaging unit 4 may share the same imaging optical system and the same imaging element.

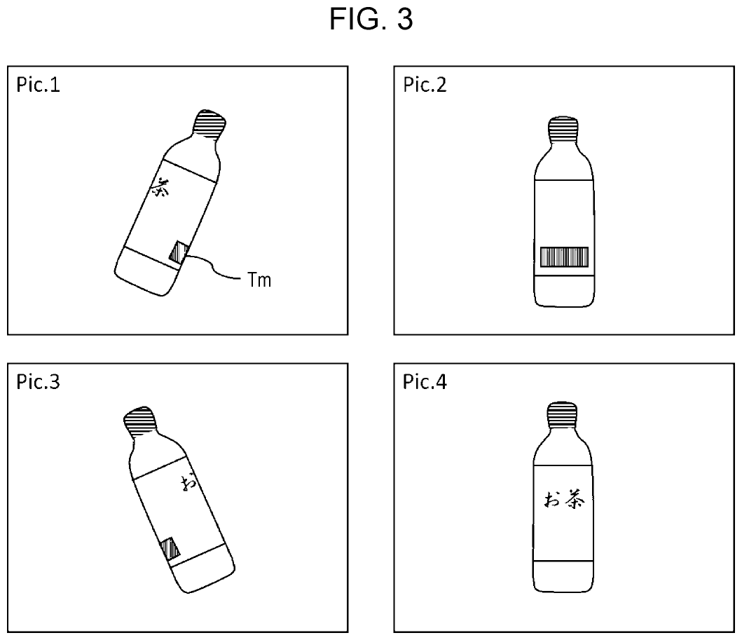

FIG. 3 is a conceptual diagram illustrating captured images of the imaging target T captured and generated by the imaging unit 4.

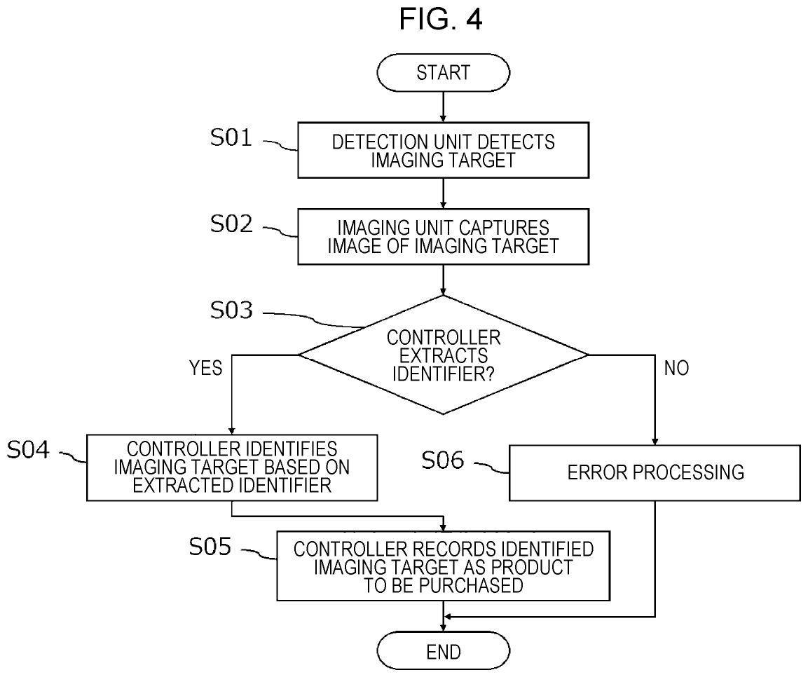

For example, assuming that the gate 3 includes four imaging units 4, four captured images are generated as illustrated in FIG. 4.

In this case, the identifier Tm of the imaging target T is clearly seen in one of the four captured images, or the image Pic. 2.

The controller 2 performs image recognition processing on the four captured images and selects the captured image Pic. 2, in which the identifier Tm is clearly seen. The controller 2 identifies the imaging target T by using the selected captured image Pic. 2.

The holder 5 holds the imaging target T that has passed through the gate 3. In other words, the user puts the imaging target T into the holder 5 via the gate 3.

The holder 5 may be, for example, a detachable basket or a container as represented by a bag. The holder 5 may be disposed on a lower surface (facing the installation plane U) of the gate 3. The holder 5 may be manually fastened to the lower surface of the gate 3 by the user or may be automatically fastened to the lower surface of the gate 3 by the information processing system. For example, in the embodiment of FIG. 2, a predetermined space is left between the gate 3 and the installation plane U, and the holder 5 is placed in the space.

The database 6 stores associated information related to the imaging target T. Examples of the associated information include a product name, a price, a product image, and the identifier Tm.

The database 6 includes at least one memory. The memory may include one or more of any of semiconductor memories, magnetic memories, and optical memories. The semiconductor memories may include a volatile memory and a nonvolatile memory. The magnetic memories may include a hard disk and a magnetic tape. The optical memories may include a CD, a DVD, and a BD.

The presentation unit 7 presents information associated with an identifying process for the imaging target T by the controller 2. The presentation unit 7 may present, for example, any of the product name of the imaging target T identified by the controller 2, the price thereof, and the number of imaging targets T. The presentation unit 7 may present any of a product name list of one or more imaging targets T identified by the controller 2, the sum of prices, and the sum of the numbers of imaging targets T. If the imaging target T fails to be identified, the presentation unit 7 may present an error and prompt the user to again put the imaging target T or prompt the information processing system to again identify the imaging target T with a code scanner that is optionally included in the information processing system. The code scanner may be based on a scheme for code scanning including scanning with a CCD, scanning with a laser beam, and scanning with a pen.

The presentation unit 7 may include at least one selected from the group consisting of a display, a speaker, a motor, and a light emitting device or may include a combination of at least two or more selected from the above group. The light emitting device may be a halogen lamp, a light emitting diode (LED) lamp, an electro luminescence (EL) lamp, or the like. The presentation unit 7 may cause the display to display image information. The presentation unit 7 may cause the speaker to generate an audio output. The presentation unit 7 may cause the motor to vibrate. The presentation unit 7 may cause the light emitting device to emit light.

The controller 2 and the database 6, which are not illustrated in FIG. 2, may not be included in the same information processing apparatus. For example, the information processing system may include at least one optional computing unit, and the computing unit may include the controller 2 and the database 6. The detection unit 1 and the imaging unit 4 included in the same information processing apparatus of the information processing system may communicate with the controller 2 and the database 6 included in the computing unit. The computing unit may be, for example, a computer, a server, a cloud service, or a combination thereof. In FIG. 2, the presentation unit 7 is separate from the detection unit 1, the gate 3, and the imaging unit 4 integrated with each other. For example, the presentation unit 7 may be embedded in an outer surface (opposite the inner surface in the cavity) of the gate 3.

A flowchart of an image capture and recognition process by the information processing system in accordance with the present disclosure will be described with reference to FIG. 4.

FIG. 4 is a diagram illustrating the flowchart of the image capture and recognition process by the information processing system.

<S01> The detection unit 1 detects an imaging target T. The detection unit 1 then transmits a detection signal to the controller 2. After that, the process proceeds to <S02>.

<S02> Upon receiving the detection signal, the controller 2 transmits an image capture signal to the imaging unit 4. In response to receiving the image capture signal, the imaging unit 4 captures an image of the detected target and generates a captured image. The imaging unit 4 then transmits the captured image to the controller 2. After that, the process proceeds to <S03>.

<S03> Upon receiving the captured image from the imaging unit 4, the controller 2 performs image recognition processing on the captured image and tries to extract the identifier Tm of the imaging target T. If the controller 2 successfully extracts the identifier Tm of the imaging target T, the process proceeds to <S04>. If the controller 2 fails to extract the identifier Tm of the imaging target T, the process proceeds to <S06>.

<S04> If the controller 2 successfully extracts the identifier Tm of the imaging target T, the controller 2 identifies the imaging target T based on the extracted identifier Tm. After that, the process proceeds to <S05>.

<S05> After the controller 2 identifies the imaging target T, the controller 2 records the identified imaging target T as a registration target. A recording destination is, for example, the recording unit included in the controller 2. After that, the process is terminated.

<S06> If the controller 2 fails to extract the identifier Tm of the imaging target T, the controller 2 performs error processing. The error processing involves, for example, transmitting a presentation signal from the controller 2 to the presentation unit 7 and presenting, by the presentation unit 7, an error indicating that the imaging target T has failed to be identified. After that, the process is terminated.

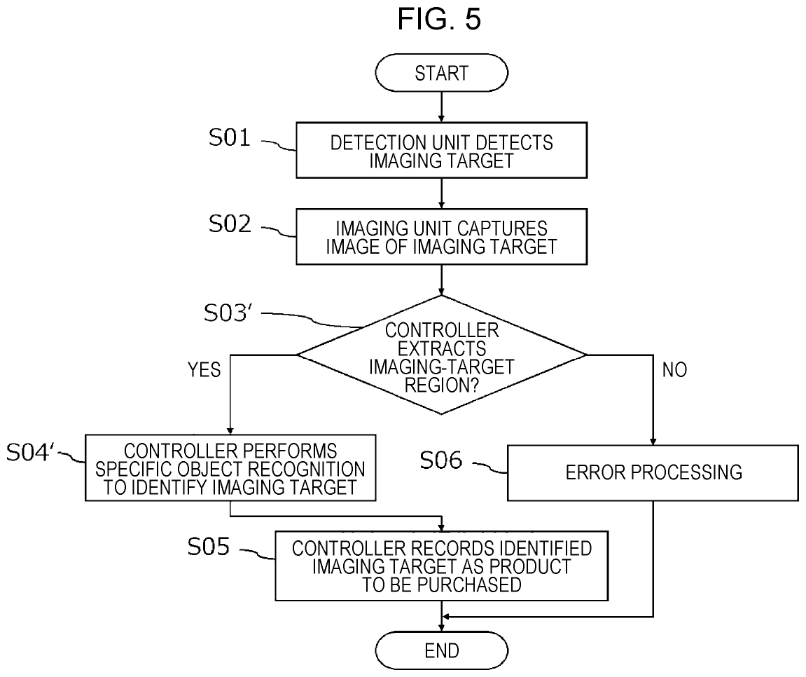

In the flowchart of the image capture and recognition process by the information processing system of FIG. 4, the imaging target T is identified based on the identifier Tm. For example, specific object recognition can be used. A flowchart of an image capture and recognition process involving specific object recognition by the information processing system will be described with reference to FIG. 5.

In FIG. 5, <S01>, <S02>, <S05>, and <S06> are the same steps as those for identifying the imaging target T based on the identifier Tm in FIG. 4. A description of these steps is omitted.

<S03′> Upon receiving the captured image from the imaging unit 4, the controller 2 performs image recognition processing on the captured image and tries to extract an imaging-target-T region in which the imaging target T is seen. If the controller 2 successfully extracts the imaging-target-T region including the imaging target T, the process proceeds to <S04′>. If the controller 2 fails to extract the imaging-target-T region including the imaging target T, the process proceeds to <S06>.

<S04′> If the controller 2 successfully extracts the imaging-target-T region including the imaging target T, the controller 2 performs specific object recognition on the extracted imaging-target-T region to identify the imaging target T. After that, the process proceeds to <S05>.

It is to be noted that, while the image registration system in the present disclosure has been described with reference to the drawings and the embodiments, those skilled in the art can easily make various changes and modifications based on the present disclosure.

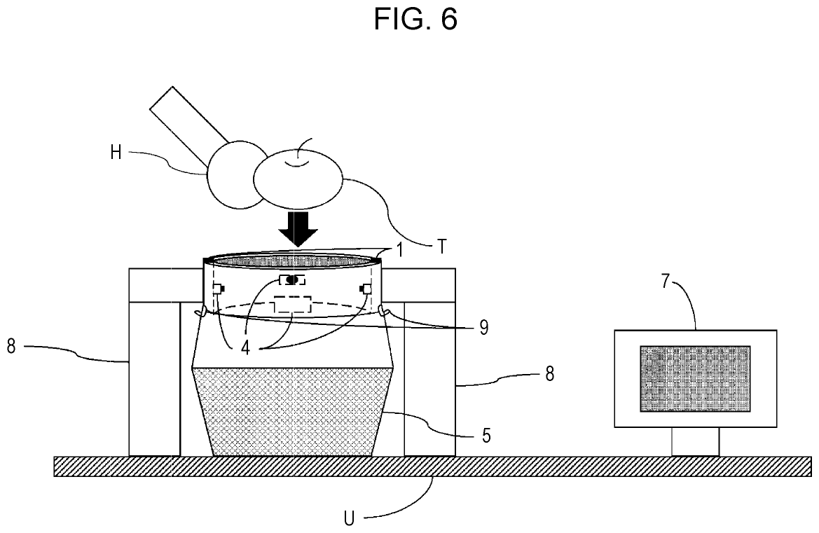

FIG. 6 is an external view of an information processing apparatus in another embodiment of the present disclosure.

For example, as illustrated in FIG. 6, the gate 3 may be located at a shorter distance from the installation plane U than that in the embodiment illustrated in FIG. 2.

As illustrated in FIG. 6, the gate 3 may include catching portions 9 for catching handles of the holder 5. The catching portions 9 may be, for example, hooks or stoppers.

In the information processing system, a light emitter that emits light simultaneously with image capture by the imaging unit 4 may be disposed inside the cavity of the gate 3. The light emitter disposed in this manner may cause an increase in brightness of a captured image and facilitate identification of an imaging target T.

The controller 2 may perform correction processing on a captured image captured by the imaging unit 4. The correction processing may include correction of, for example, color saturation, color tone, contrast, distortion, and the like. The correction processing may be performed to enable extraction of the identifier Tm of an imaging target T or an imaging-target region from the captured image. The correction processing may facilitate extraction of the identifier Tm of the imaging target T or the imaging-target region from the captured image.

If, for example, a hand or arm of the user is seen in the captured image captured by the imaging unit 4, the controller 2 may recognize the hand or arm and identify the imaging target T in consideration of the presence of the hand or arm. For example, if the controller 2 determines that the identifier Tm is covered by a hand H in the captured image, the controller 2 may identify the imaging target T by performing specific object recognition. If the controller 2 determines that an imaging-target-T region other than the identifier Tm is covered by the hand H in the captured image, the controller 2 may identify the imaging target T by recognizing the identifier Tm.

The holder 5 may include a sensor that determines whether the imaging target T is held in the holder 5. The sensor may be, for example, a photoelectric sensor, a fiber sensor, a laser sensor, an ultrasonic sensor, an image sensor, or a weight sensor. In response to determining that the imaging target T is held in the holder 5, the sensor disposed in the holder 5 transmits a holding signal to the controller 2. The controller 2 may compare the holding signal to the presence or absence of reception of a captured image from the imaging unit 4 to determine whether the imaging target T is appropriately held. If it is not determined that the imaging target T is appropriately held, that is, if the controller 2 has already received a captured image but has not yet received a holding signal, or if the controller 2 has not yet received a captured image but has already received a holding signal, the controller 2 may perform error processing.

The presentation unit 7 may perform presentation not to the user but to a store employee or a system manager, for example. In this case, the user is a customer in a store. Presentation to the store employee or the system manager may allow the store employee or the system manager to grasp the progress of the image capture and recognition process and rapidly help the user as necessary.

In the present disclosure, the user is not limited to a customer. The user may be, for example, a store employee or a system manager.

In the present disclosure, a captured image or an imaging-target region, in which an imaging target T is seen, captured by using the information processing system may be associated with the identified imaging target T and be recorded in the database 6. Associating the captured image or the imaging-target region with the imaging target T in the database may facilitate additional collection of image data for pattern matching or machine learning, for example.

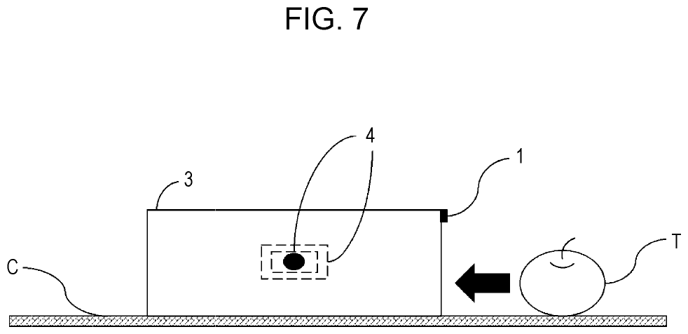

In the present disclosure, the information processing system and the information processing apparatus can be used to classify or discriminate an imaging target T on a transport path C, such as a belt conveyor. For example, as illustrated in FIG. 7, the information processing apparatus may be installed above a belt conveyor. FIG. 7 is an external view of the information processing apparatus installed above the belt conveyor. In this case, the user may be, for example, a site worker or an operation supervisor.

While the information processing system, the information processing apparatus, and the information processing method have been described as solutions in the present disclosure, it is to be understood that the present disclosure may be realized as a program that may be realized as an implementation including the information processing system, the information processing apparatus, and the information processing method and substantially corresponds thereto and may also be realized as a storage medium storing the program. It is to be understood that the program and the storage medium are encompassed within the scope of the present disclosure.

### Reference Signs

1 detection unit

2 controller

3 gate

4 imaging unit

5 holder

6 database

7 presentation unit

8 support

9 catching portion

H hand

T imaging target

Tm identifier

1. An information processing system comprising:
an imaging unit configured to capture an image of an imaging target in a multi-view manner to generate a captured image;
a gate including the imaging unit and allowing the imaging target to pass therethrough; and
a controller configured to extract a predetermined region including the imaging target from the captured image and identify the imaging target based on the predetermined region.

2. The information processing system according to claim 1, further comprising:
a detection unit configured to detect the imaging target,
wherein the imaging unit is configured to capture the image in response to the detection unit detecting the imaging target.

3. The information processing system according to claim 1, further comprising an accommodation, wherein
the accommodation is configured to accommodate the imaging target that has passed through the gate.

4. The information processing system according to claim 1, wherein
the gate comprises an inner surface, and
the captured image includes a view facing the inner surface.

5. The information processing system according to claim 1,
wherein the imaging unit is further configured to generate one or more captured images, wherein
the controller is configured to:
select at least one of the captured images that satisfies a predetermined condition;
extract a predetermined region including the imaging target from the selected captured image; and
identifies the imaging target based on the predetermined region.

6. An information processing apparatus comprising:
an imaging unit configured to capture an image of an imaging target in a multi-view manner;
a gate including the imaging unit and allowing the imaging target to pass therethrough; and
a controller configured to extract a predetermined region including the imaging target from the image captured by the imaging unit and identify the imaging target based on the predetermined region.

7. An information processing method comprising:
capturing, at an imaging unit included in a gate, an image of an imaging target passing through the gate in a multi-view manner;
extracting a predetermined region including the imaging target from the image captured at the imaging unit; and
identifying the imaging target based on the predetermined region.
